(19) United States
(12) Patent Application Publication
(10) Pub. No.: US 2013/0280385 A1
(43) Pub. Date: Oct. 24, 2013

(54) HALF-PRODUCT, PRODUCT AND IMPLEMENT FOR MANUFACTURING A MILKSHAKE

(71) Applicants: Maarten Arns, Wijchen (NL); Harry Schippers, Wierden (NL)

(72) Inventors: Maarten Arns, Wijchen (NL); Harry Schippers, Wierden (NL)

(73) Assignee: DAIRY INNOVATIONS B.V., Arnhem (NL)

(21) Appl. No.: 13/883,329

(22) PCT Filed: Nov. 4, 2011
(86) PCT No.: PCT/NL2011/050758

§ 371 Date: Jul. 8, 2013

(30) Foreign Application Priority Data
Nov. 4, 2010 (NL) 2005628

(51) Int. Cl. A23G 9/04; A23G 9/22; A47J 43/07

(52) U.S. Cl. CPC A23G 9/045; A47J 43/07; A23G 9/224
USPC 426/100; 426/518; 426/584; 426/580; 241/168

(57) ABSTRACT

Method for manufacturing a milkshake, wherein ice and a liquid with dividing means are put together in a substantially liquid-tight container, after which this container is shaken, such that the ice in the container is divided into small pieces by the dividing means, wherein the ice is preferably provided as a multiplicity of units of ice.

The invention relates to methods and means for manufacturing a milkshake.

The term milkshake should be understood to mean, inter alia, cold, airy, thick-liquid drinks, obtained by mixing ice and, for example, milk, fruit, fruit pulp, fruit drinks, jam, fruit syrup, chocolate milk, and the like. It is of importance here that the ingredients are properly mixed, that the temperature of the mixture is preferably lower than 0° C., more preferably between −2° C. and −1.5° C., and that, preferably, the viscosity is such that the mixture can be consumed through a straw. By introducing gas such as air into the mixture, furthermore, a better taste sensation can be obtained.

Stirring and introducing gas into the mixture can be effected in different manners, as by utilizing mechanical or manual mixers or stirring rods. Also, gas or a gas containing element may be added to the mixture.

U.S. Pat. No. 6,338,569 describes a system for making milkshakes, in which a beaker has been filled with the ingredients for the milkshake and thereupon sealed with a lid. Provided on the lid or on the bottom of the beaker is a stirring element (impeller). Furthermore, the system comprises a machine in which the beaker can be placed, such that the impeller is coupled with a motor shaft of the machine, so that the impeller is driven in the beaker, for mixing the ingredients or dividing them.

WO00/49930 also describes a system for making milkshakes, in which again a beaker is filled with the ingredients for the milkshake and is closed with a lid. Also in this system, a stirring element (impeller) is provided in the beaker, which can be driven by a motor of a machine belonging to the system, to mix the ingredients in the beaker, for consumption. The machine is provided with microwave generating means for heating up the frozen contents of the beaker, prior to and during stirring.

These documents therefore describe ready-to-use beakers for making milkshakes with the aid of machines especially constructed for that purpose, which by stirring bring the ingredients in a liquid, mixed condition. A drawback of existing methods is that preparing a good milkshake requires special equipment and/or that the ingredients have to be measured well. With the systems described in these documents, milkshake can only be manufactured at places especially equipped for the purpose, with the necessary machines.

An object of the present invention is providing an alternative for the manufacture of a milkshake. Another object is providing the means for manufacturing a milkshake, without special equipment, in a relatively short time. in particular, by only utilizing shaking of a container by hand. A further object is providing the means for, preferably by hand, manufacturing a milkshake from ice and a liquid, to be put together or put together in a container, whereby a fine division of the ice in the liquid is obtained, so that ice crystals distributed through the liquid are obtained and moreover a fast heat transfer between the ice and the liquid is effected.

In a first aspect the invention can be embodied by a method for manufacturing a milkshake, wherein a multiplicity of units of ice and a liquid with dividing means are put together in a substantially liquid-tight container. This container is shaken, such that the units of ice in the container are divided into small pieces by the dividing means. Shaking can be done by hand. The dividing means are arranged to further comminute the units of ice.

In another aspect the invention can be embodied by ice dividing means, provided with a multiplicity of knives for cutting units of ice. The ice dividing means can comprise a circumferential wall, which circumferential wall is preferably rollable, bendable or foldable. The knives are preferably formed by inwardly bent parts of the circumferential wall.

In yet another aspect the invention can be embodied by an assembly of units of ice and ice dividing means. Such an assembly can constitute, for example, a half-product, comprising an amount of units of ice, and dividing means for dividing the units of ice into small pieces, with the dividing means and the multiplicity of units of ice packed together in a consumer package. The dividing means may be so arranged that the units of ice can be divided into small pieces by taking the dividing means with the units of ice present therein out of the package and placing them in a substantially liquid-tight container and shaking this container along with liquid added by a user in the container. The concept of ice in this connection may be understood to encompass at least, though not limited to, consumer ice, such as ice-cream, water ice, frozen curd, frozen fermented product such as yoghurt, and so forth.

In other aspects the invention can be embodied in a product or in an implement for manufacturing a milkshake.

The invention will be elucidated on the basis of exemplary embodiments represented in the drawings, in which:

FIGS. 1, 2 and 3 show in perspective a product according to the invention in different stages of manufacture of a milkshake;

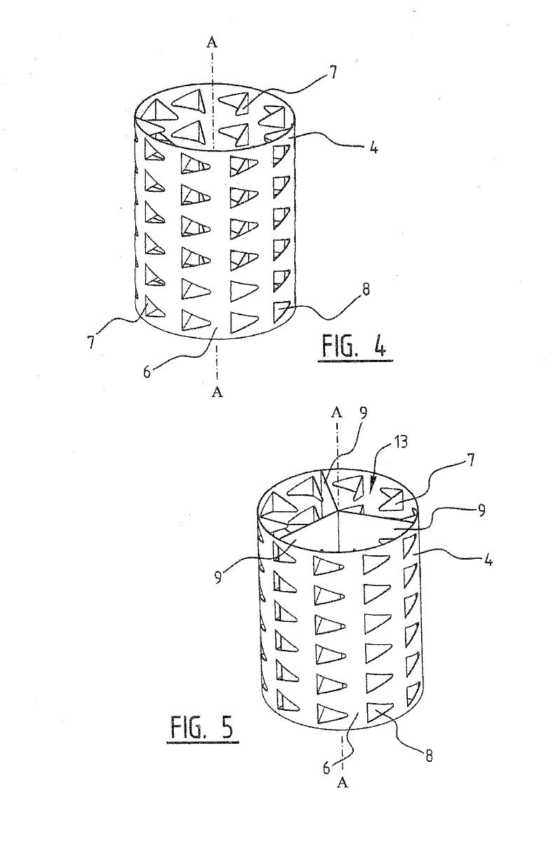

FIG. 4 shows in perspective the ice dividing element from FIGS. 1, 2 and 3;

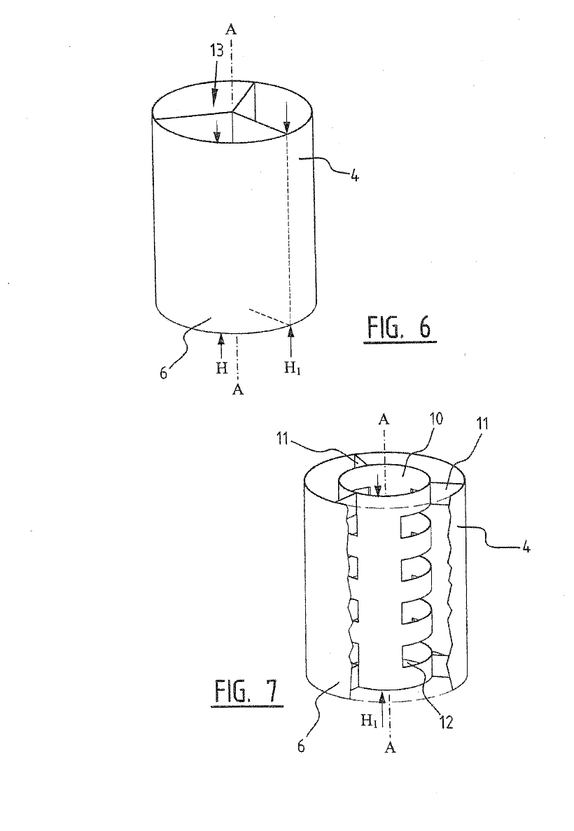

FIGS. 5, 6, 7, 10 and 11 show in perspective alternative embodiments of an ice dividing element;

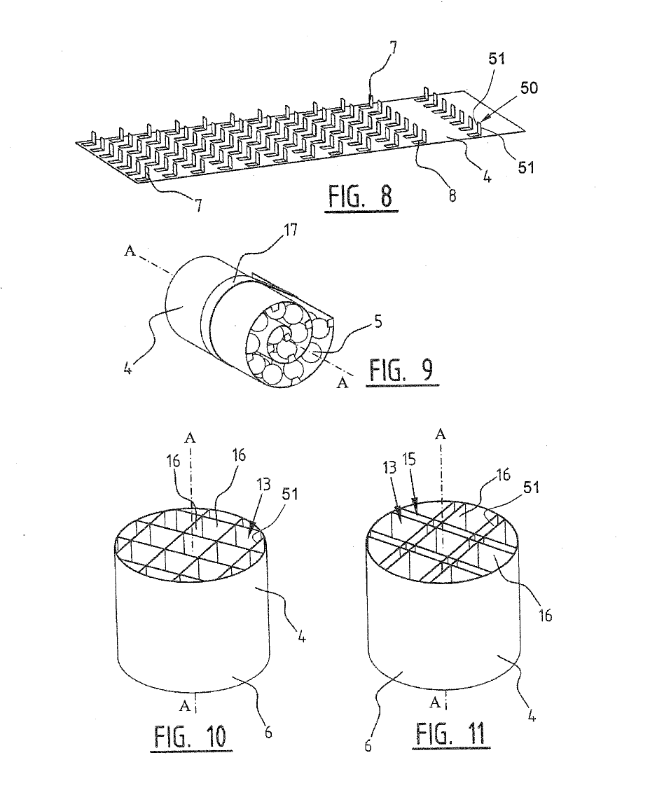

FIGS. 8 and 9 show in perspective an embodiment of a rollable ice dividing element, the ice dividing element in FIG. 9 being rolled up with small balls of ice in it;

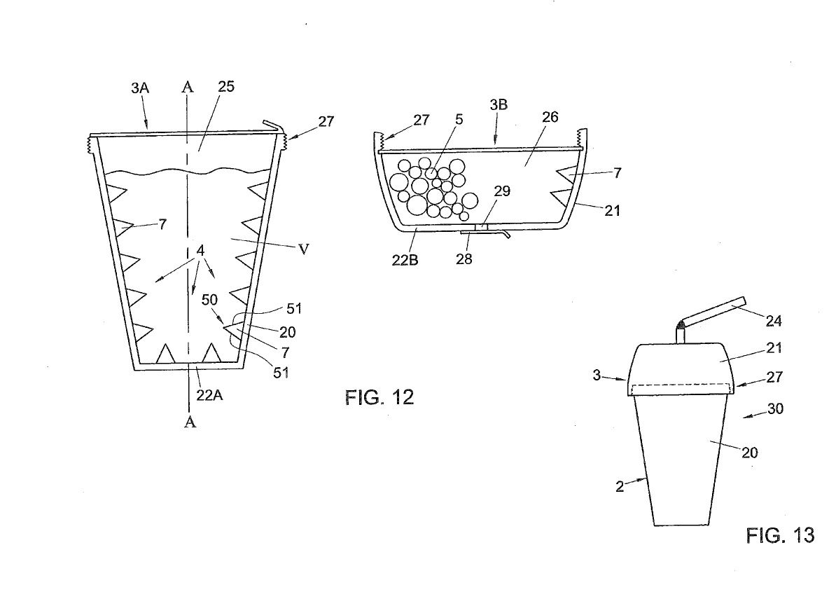

FIGS. 12-17 show alternative assemblies and packages for manufacturing a milkshake;

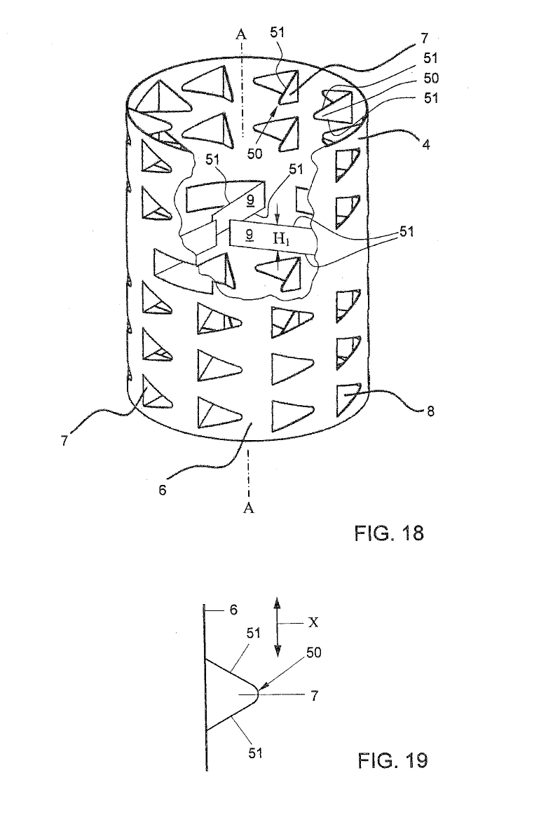

FIG. 18 schematically shows a dividing means according to the invention, partly cutaway, with radial walls;

FIG. 19 shows a knife of a dividing means, having an alternative shape;

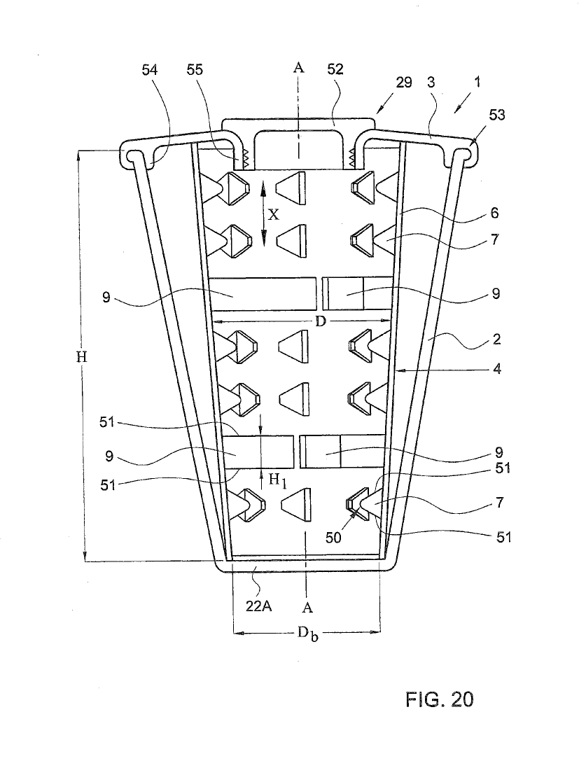

FIG. 20 shows a container with dividing means, without the ice units, partly in cross section, provided with a sealable opening in the lid;

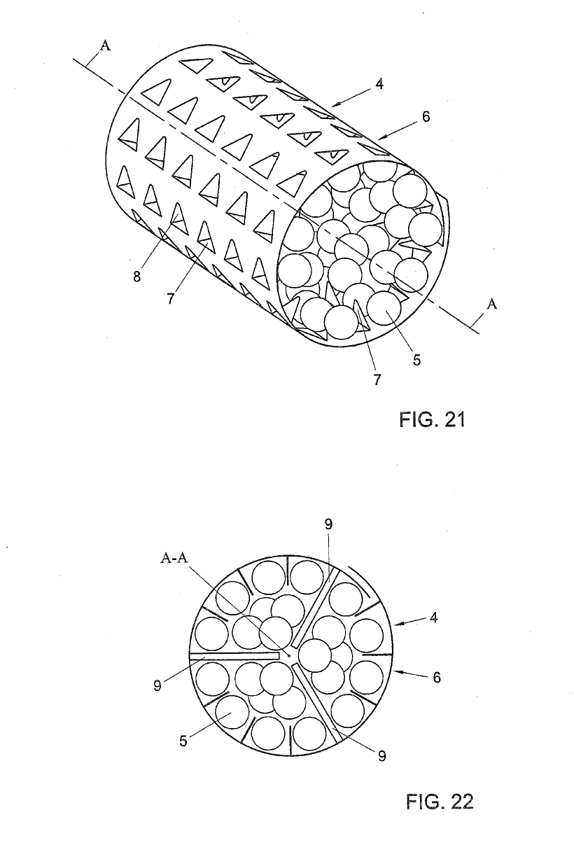

FIG. 21 shows in perspective an ice dividing element, with ice units;

FIG. 22 schematically shows in top plan view an ice dividing element, with ice units;

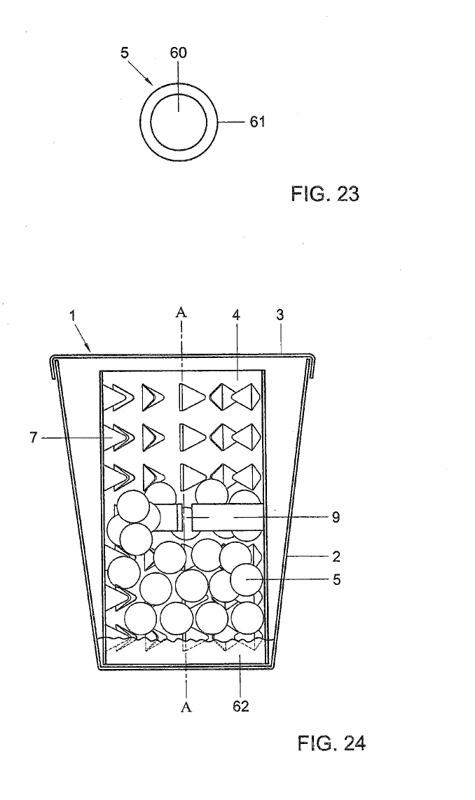

FIG. 23 shows an embodiment of an ice unit in cross section; and

FIG. 24 shows a container with ice dividing means, for example as shown in one of the foregoing figures, having therein ice units and additive.

In this description a number of examples are given of methods and assemblies or parts therefor for the manufacture of a milkshake product. These are mentioned only as examples and as such should not be construed as limiting the invention in any way. In this description the same or comparable parts have the same or comparable reference numerals.

In this description, units of ice should be understood to mean at least, though not exclusively, ice in units at least largely separated from each other, which units are relatively small with respect to their joint volume. Units may be individual units physically separate from each other or may be mutually connected, forming interspaces filled with gas such as air. In such an embodiment the units may be taken up jointly as a unit or ice body and, for example, packed, placed in a (partial) container and the like.

The units are preferably chosen such that they can lie against each other with interspaces in which gas or liquid can move. The units are preferably manufactured as ice or from ice containing a relatively high percentage of gas, in particular air, for example an overrun of 60% or more, more in particular at least 70%, for example, between 70% and 100%. In this description overrun of ice should be understood to mean the difference between the mass of the ice-air mixture and the volume thereof. An overrun of 100% hence means that the mass volume of the ice times 2.0 is the total volume, which can be understood as ice whose total volume is determined for at least 50% by the amount of air present therein. The units of ice are preferably spherical, which allows the liquid to spread easily between the units of ice when these are in mutual abutment. In another embodiment the units of ice are mutually connected, for example, thereby forming an ice body, such that they define a structure of continuous channels or pores through which gas or liquid can move. In the following description, airy liquid should be understood to mean at least a liquid in which at least 25% of the volume is taken up by gas, in particular air. An airy liquid may be, for example, a foamed liquid or a liquid provided with a component or ingredient that foams when shaken or by contact with the ice or with air.

In this description liquid should be understood to mean at least an ingredient or mixture of ingredients having a viscosity that is lower than the viscosity of the ice. A liquid can be, for example, an ingredient or assembly of ingredients which is pourable or which are jointly pourable.

The dividing means and the units of ice are preferably so designed that a good heat transfer between liquid and ice can take place, as a result of which, preferably, the milkshake can be manufactured within 30 seconds. In this description dividing means should be understood to include a dividing means, dividing element, ice dividing element, an ice dividing means and ice dividing means, which terms are interchangeable, unless indicated otherwise.

The dividing means are preferably not engageable for drive from an outside of a container in which they are confined. The dividing means are preferably so arranged that they can be confined within a container and then cannot be driven from the outside of the container with the aid of, for example, a motor. The dividing means may in embodiments be substantially restrained from movement within a container in which they are confined, at least in one direction, in particular an axial direction of a container in which they are received, and preferably in any direction.

The dividing means are preferably provided with a multiplicity of knives for cutting the units of ice. The units of ice may then, as a result of shaking, be moved against the cutting edges of the knives. In that connection, the knives preferably extend in axial direction. The knives can have cutting edges facing opposite sides. The dividing means may be provided with holes, through which during shaking air is introduced into the mixture. The knives and holes are preferably formed by bent parts of a circumferential wall, and the knives preferably have a substantially triangular shape. Furthermore, the knives are preferably substantially uniformly spread over the surface of the circumferential wall. The protruding knives during shaking also cause turbulence in the mixture already cut, thus promoting incorporation of air.

In embodiments the knives can have a rounded point, while the sides of the knives 7 can constitute cutting faces or cutting edges 51 and the points 50 are relatively blunt. This can reduce the chance of injury to a user, should the user be able to reach the knives.

The invention may be embodied in a product for manufacturing a milkshake, comprising a substantially liquid-tightly closable container for holding the milkshake to be manufactured, a multiplicity of units of ice arranged in the container, and dividing means present in the container for dividing the units of ice into small pieces, the dividing means being set up in the container such that the units of ice can be divided into small pieces by shaking the container with the units of ice present therein and liquid added by a user.

The invention may also be embodied in an implement for manufacturing a milkshake, comprising dividing means for dividing units of ice into small pieces, the dividing means being so arranged that the units of ice can be divided into small pieces by placing the dividing means with the units of ice present therein in a substantially liquid-tight container and shaking this container together with liquid added by a user in the container.

In a method or assembly according to the invention, in a container 1 ice dividing means 4, units of ice 5 and a liquid V are put together, after which the container 1 is shaken, such that the units of ice 5, which already have a relatively small individual volume with respect to the internal volume of the container 1, are still further comminuted and possibly wholly or partly separated from each other relatively fast by the dividing means, such that the heat transferring surface of the ice is still further enlarged. As a result, fast and effective heat transfer between the ice and the liquid will be obtained, as a result of which a milkshake product will be formed in which at least individual ice crystals of the ice will be identifiable, visible and present in such a manner that the flavor is released from the mixture in a delayed manner, in particular as a result of melting of the crystals, preferably in the mouth. Ice crystals should herein be understood to mean at least ice crystals that consist of the original ingredients. Preferably, the ice crystals are not crystals of frozen water. Atmospheric pressure is the starting point in determining temperatures of the different parts of an assembly according to the invention.

In the embodiment shown in FIGS. 1-3, a product for manufacturing a milkshake comprises a container 1, such as a beaker 2. In an embodiment, the container 1 can be or comprise a substantially cylindrical beaker 2. This can have a contents of, for example, a few hundreds of milliliters, for example, about 600 ml, although, of course, other volumes and shapes are possible. On the container a lid 3 is provided or to be attached, for closing the container 1, preferably liquid-tightly. An ice dividing element 4 may be provided or be inserted in the container 1, as well as an amount of units of ice 5. In FIGS. 1-3 a substantially cylindrical ice dividing element 4 is shown, in which balls of scoop ice 5 are arranged. The ice dividing element 4 can constitute ice dividing means or be part thereof

The ice dividing means may be placed in the container such that during shaking they can move in the container. In the embodiment of FIGS. 1-3, the ice dividing element 4 is substantially cylindrical and is inserted with the longitudinal axis A approximately parallel to the longitudinal axis B of the beaker 2. In this embodiment the diameter of the ice dividing element 4 may be smaller than the diameter of the beaker 2 and/or the length measured in the axial direction may be slightly smaller than the height of the beaker in axial direction. In the exemplary embodiment shown in, for example, FIG. 1, the diameter of the ice dividing element 4 is, for example, about 10%-20% smaller than the diameter of the container 1, and the length of the ice dividing element 4 is about 5 to 70% smaller than the height of the container 1. Alternatively, the ice dividing element 4 may be so configured that moving thereof within the container in the axial direction and/or in radial direction is at least largely prevented. In a further alternative embodiment the dividing element 4 can be part of the container 1, in particular of the beaker 2 and/or the lid 3, while only the ice units 5 and/or the liquid need to be added, prior to shaking The dividing element in this embodiment may be a part of the beaker 2 and/or the lid 3, and, for example, be integrally formed therewith, or may be detachably arranged, for example, for simplified cleaning and reuse. The dividing element 4 may then be provided, for example, with coupling means for coupling with the beaker 2 and/or lid 3. Alternatively, in the beaker dividing elements may be provided integrally, such as knives 7 to be described later. Of importance, it seems, is that the ice moves relative to the dividing means, in order to obtain division of the ice and/or air impact in the mixture of ice and liquid. Ice crystals are thereby distributed through the liquid.

The closed or closable container 1, and the ice dividing element 4 with the balls of scoop ice 5 therein can be sold as a product to the consumer. Alternatively, only the ice dividing element 4 with the balls of ice 5 therein may be sold to the consumer in a disposable package, while the consumer can purchase the container 1 separately, filled with a liquid or not. Depending on the kind of ice product the product may also be sold in thawed condition and be frozen in a freezer at home by the consumer himself.

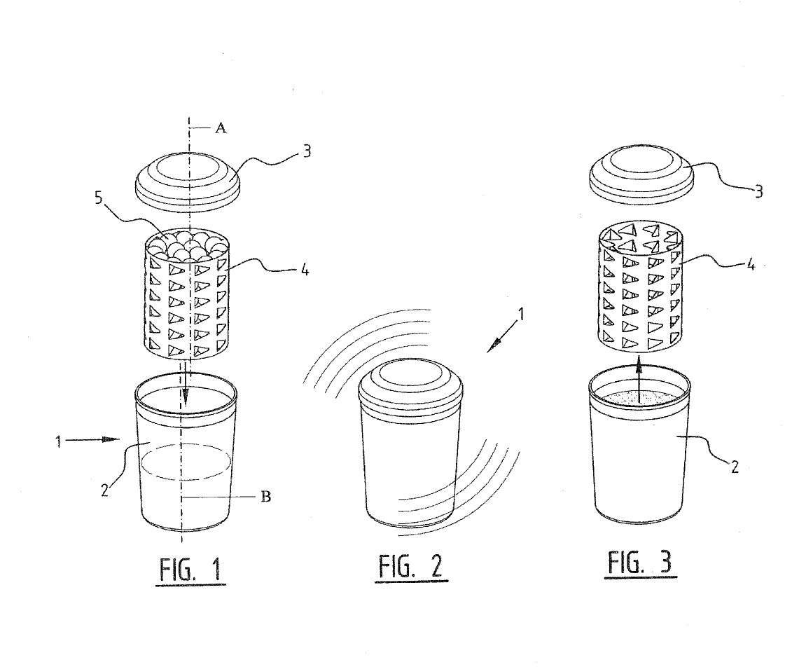

In both cases the consumer, after purchase, fills the container 1, having therein the ice dividing element 4 with the frozen ice balls 5, with, for example, cooled milk (FIG. 1). Thereupon the consumer closes the beaker 2 with the lid 3 and shakes it for, for example, about 30 seconds (FIG. 2). Thereupon the container 1 may be opened and the ice dividing element 4 can optionally be removed. The ice dividing element 4 may also be left sitting, and the milkshake may be drunk with a straw or, for example, be poured out.

The ice dividing element 4 according to FIG. 4 comprises a cylindrical wall 6 of thin plastic sheet material, in which by means of V-shaped dies small triangular knives 7 are formed which are inwardly bent, so that in the circumference of the wall holes 8 are formed. The knives 7 extend in the axial direction. The ice dividing element according to FIG. 5 comprises furthermore three walls 9 which extend from the axis of the wall, radially outwards to the wall 6, so that three compartments 13 are formed in the ice dividing element 4. These walls 9 serve also as knives to divide the ice. In a variant on the embodiment of FIG. 4, such as schematically shown, for example, in FIG. 18, the walls 9 also extend approximately towards or beyond the central axis from the cylindrical circumferential wall, but they are not connected with each other there, and furthermore they extend only over a portion of the length of the cylindrical circumferential wall 6, for example, in a middle portion thereof. In that way, these wall parts form flexible knives, which can create turbulence and which can at least co-prevent the formation of a large lump of ice. Knife in this application should be understood to also encompass an element which in the container contributes to distribution of the ice through the liquid and/or to air incorporation into the mixture of ice and liquid. Such air incorporation can be effected, for example, though not exclusively, by mechanical energy which is obtained from shaking movements of the container, so that at least a part of the ingredients is guided along the dividing means such as the knives. Mixture should be understood to also encompass a suspension. Air incorporation should herein be understood to also encompass foam formation in the liquid and/or the mixture of liquid and ice.

In FIG. 21 comparable ice dividing means are shown, where, however, the wall 6 does not run spirally, as in FIG. 4, but is substantially cylindrical. A part of the ice units then will not lie against the wall 6 and/or against one of the knives 7, but be brought into contact therewith upon shaking

In FIG. 22 in an end view an ice dividing element 4 is shown, partly filled with ice units 5. Also in this embodiment, the wall 6 is substantially cylindrically wound, with ice units 5 arranged therein that may be of such dimension that they do not all lie against the wall 6 and/or knives 7 and/or walls 9. The ice units, as described earlier, can be placed on the wall 6 when it has not yet been rolled up or folded into a tube, but may also be loosely dumped in the cylindrical ice dividing element 4 formed into or as a tube. Surprisingly, it has been found that despite the fact that the ice units can be dumped between the knives 7 and/or walls 9 and can pass therebetween, they will yet be divided into smaller units when the container having therein the ice units and liquid is shaken.

In FIG. 19 an alternative embodiment of a knife 7 is shown, in which the point 50 is rounded, so that as such it is not particularly sharp anymore. Should a user stick a finger into the container, for example, through an opening in the lid through which, for example, the liquid can be poured into the container and/or the milkshake can be poured out or consumed, then, preferably, the knives are not accessible but when the point 51 is relatively blunt, moreover, the chance of injury by the knives can be further reduced.

In embodiments such as shown, the edges 51 of the knives 7 and possibly of the walls 9 may substantially form the actual cutting edges or cutting faces. These can, upon shaking of the container, extend into the paths of movement of the units of ice, such that the units are cut thereby, while the position and shape of the knives and/or walls can provide that they are stiffer in an axial direction of movement of the ice units than in directions at right angles thereto, for example, a tangential direction. Axial movement direction X should herein be understood at least as a direction that comprises a component in the direction parallel to the axis A-A of the container, in particular is approximately parallel thereto, or substantially parallel to an axis of a cylinder formed by the dividing means. The axial direction X-X may thus, for example, be directed substantially between a bottom and lid of a container 2. Comparable walls or wall parts 9 can naturally be used in all embodiments.

In all embodiments, it holds that upon shaking of the container having therein the ice, in particular the units of ice and the liquid, preferably at least the ice moves relative to the dividing means, as a result of which turbulence and/or mechanical forces are generated in the liquid that provide for cutting of the ice and for a fast heat transfer between the ice and the liquid. In particular, the ice is thereby forced at least in an axial direction of the container and/or the dividing means.

FIG. 6 shows an embodiment of an ice dividing element 4, in which the knives 7 and the holes 8 in the circumferential wall 6 of FIG. 5 are omitted. In it, the walls 9 are shown, as knives. In this embodiment, the walls 9 can extend throughout the axial height H of the wall, but preferably they have a lesser axial height H1, as shown, for example, in FIG. 18, so that more effective cutting edges 51 can be formed. Moreover, along the height H, also, at different levels several wall parts 9 may be provided.

FIG. 7 shows an embodiment in which within the circumferential wall 6 a cylindrical inner wall 10 is arranged, between which radial connecting elements 11 extend. In the inner wall 9 holes 12 are provided. The edges of the holes 12, the connecting elements 11 and the walls 6, 10 all function as knives during shaking

FIG. 10 shows an embodiment in which in the cylindrical circumferential wall 6, by means of flat walls 16 in a diamond pattern, axially extending compartments 13 are arranged, which are filled with balls of ice 5. Here too, the edges 51 of the walls 6, 16 function as knives. FIG. 11 shows a variant in which the compartments are of different size, only the large compartments 13 being filled with balls of ice 5. As a result, the liquid can flow freely through the intermediate small compartments 15, which promotes the heat transfer.

FIGS. 8 and 9 show an embodiment in which the balls of ice 5 are arranged on a flat wall 6, manufactured from thin plastic, which is provided with small punched and bent rectangular knives 7 on which the balls of ice 5 are pressed and fixed. Thus the half-product is packed in a disposable package. The consumer, after purchase, can roll up the ice dividing element 4 with the balls of ice 5 to form a cylindrical element, for example, utilizing a form closure in the dividing element or with externally arranged means, such that the knives 7 extend, for example, wholly or partly in axial direction.

In embodiments according to the invention, a disposable package may also be formed at least partly by a container 1 or a part thereof.

In alternative embodiments the ice dividing element 4 with the frozen ice balls 5 is packaged in a first partial container 20, and the liquid V, for example, cooled milk, is packaged in a second partial container 21. Both partial containers 20, 21 may be provided with a lid 3A, 3B, for example, foil covers, rip off seals, plastic lids or like simply removable sealings. After the lids 3A, 3B of the two partial containers have been removed, the contents of the two partial packages 20, 21 can be put together and shaken, for the formation of the milkshake. For example, the two partial containers 20, 21, after opening, may with the open sides 25, 26 be attached, for example screwed, to each other, thereby forming one container 1, and the whole can be shaken. One of the two bottoms 22A, B of the partial containers 20, 21 is then, for example, provided with a sealed opening 23 for inserting a straw 24 which may be supplied along with the containers. Alternatively, the parts of the assembly may be divided differently between the two or more partial containers. Examples of this will be described.

In FIG. 12 a first and second partial container 20, 21 are shown separate from each other and in closed condition. The first partial container 20, further also referred to as beaker 2, is, for example, cup-shaped and can be a disposable beaker. Alternatively, this beaker 2 may be intended for reuse. In the beaker the dividing means 4 are provided, for example, as described hereinbefore. These dividing means may be a dividing element 4, for example, as described with reference to FIGS. 1-11, but may also, as indicated earlier, be integrally formed with the beaker 2, for example, though not limited to, knives 7 which extend inwardly from the wall of the beaker 2. In the beaker 2, moreover, a liquid V may be received, for example, an airy liquid. The open side 25 of the beaker 2 is closed off by a lid 3A, here shown as a foil seal, for example an aluminum or plastic seal which is attached to an edge of the beaker 2 and preferably seals gas- and liquid-tightly. The second partial container 21 is shown in this embodiment as a box-shaped container likewise having an open side 26, closed off by a lid 3B, which may be designed similarly to the lid 3A. The second partial container 21 can include the units of ice 5. The second partial container 21 may also include at least a part of the ice dividing means 4. Preferably, the first and second partial containers 20, 21 are provided, near their open side 25, 26, with complementary coupling means 27, so that at least after removal, and preferably also before removal of the lids 3A, 3B, the partial containers 20, 21 can be coupled, as shown in FIG. 13. These coupling means 27 can comprise, for example, screw thread or a clamped coupling.

An assembly of a first and second partial container 20, 21 may, in the coupled position in which the lids 3A, 3B close off the two partial containers 20, 21, be stored in a freezing compartment and offered, as a package 30, for example at a temperature far below 0° C., for example, though not limited to, below −10° C., more in particular below −15° C., for example approximately −18° C. It will be clear that this temperature can be chosen on the basis of, for example, the desired storage duration, the composition of the liquid and the ice and like criteria clear to the skilled person. Both the liquid and the ice can then assume a frozen state. A user will separate this package 30 before use into the first and second partial containers 20, 21. The first partial container 20 can be stored in a refrigerator, for example at a temperature just above 0° C., for example between 0° C. and 6° C., to thaw, while the second partial container 21 can be stored in a freezing compartment at a temperature such that the ice remains frozen. Possibly, it may be elected to heat up the liquid artificially, for example by use of an oven or microwave.

After the liquid has thawed the two partial containers can be opened and the second partial container 21 can be emptied into the first partial container 20, by arranging the second partial container 21, for example, over the open top 25 of the first partial container and coupling it therewith. The second partial container 21 then in effect forms the lid 3 for the beaker 2, formed by the first partial container 20. Then the thus formed package only needs to be shaken for some time, preferably less than 30 seconds, for the formation of the milkshake.

As shown in FIG. 13, the bottom 28 of one of the partial containers 20, 21, here the second partial container 21, may be provided with an opening 29 which is initially closed off by a sealing, for example a seal such as a sticker, adhesive lip, breaking lip or the like. Through this opening a straw can be inserted to drink the milkshake. In the assembled package, the dividing means remain present in the milkshake. Thus, additional shaking to obtain further division or, for example, additional aeration, remains possible.

Alternatively, the two partial containers can be offered apart from each other, so that they can be stored at different temperatures. In this way, the ice can be kept frozen while the liquid remains liquid and thawing it therefore is not necessary.

In a further alternative embodiment, an assembly of two containers, coupled or not so, is stored at a temperature above 0° C., for example between 0 and 7° C., for example, such that at least the liquid remains liquid, while a user, for example at home, prior to use, stores the components of the assembly separately. The component, i.e., the partial container which includes the ice, can then for example be placed in a freezing compartment, at a temperature far below 0° C., for example at −10° C. or lower, such as, for example, −18° C., allowing the ice if necessary to assume a frozen state again. The liquid can then be stored at a higher temperature, for example, above 0° C., as at the earlier-mentioned temperature between 0 and 7° C., such as, for example, approximately 6° C. It is then preferred that at least the ice 5 is packaged such that the ice within the package can melt and be frozen again, so that the ice, for example, regains an original shape and constitution again. If desired, again units of ice can be obtained, in particular separate units. To this end, the package can comprise, for example, discrete, mutually separate compartments, for example formed from foil, with an amount of ice included in each compartment. The ice may also be included in one single compartment. Preferably, the package is then shaped such, and the ice is chosen such, that no condensation formation occurs or formation of ice crystals from water, especially not from water which is added from outside. Also, the ice may be included in a matrix for example soluble in a liquid to be added, or in dividing means which are so shaped and packed that upon (re)freezing of the ice voids in the dividing means are filled up wholly or partly by the ice forming, so that the ice with the dividing means can be placed together in a container and upon shaking relative movement of the ice with respect to the dividing means such as the ice dividing element 4 is possible or becomes possible.

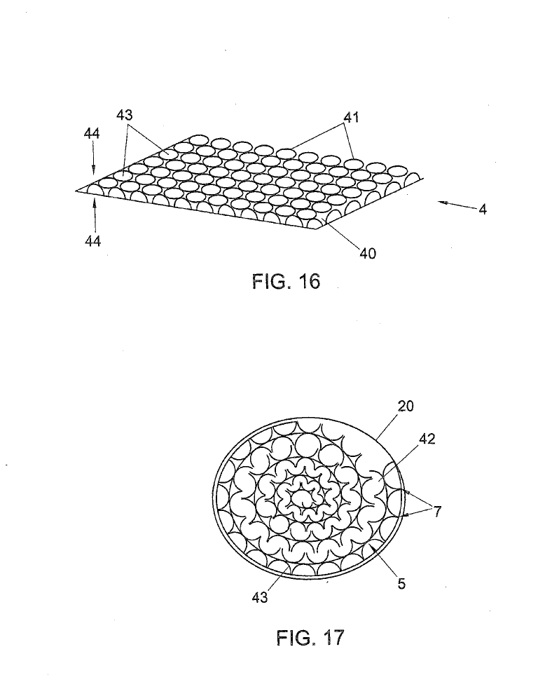

In an embodiment such as shown, for example, in FIGS. 16 and 17 the ice dividing element 4, for example, may be formed as or comprise a framework 40 of mutually connected elements 41, thereby forming at least partly open cells 42, while ice 5 can be taken up in the cells 42 for the formation of a coherent body of ice or, preferably, units of ice 5 which are at least partly separated from each other by the framework 40. In FIG. 16 an ice dividing element 4 is shown, in flat condition, in which elements 41 are shown as shell parts 43 which may be, for example, approximately half hollow spheres, which are open to two sides of the ice dividing element 4. These can be manufactured, for example, from plastic or from a consumable material. The element can be rolled up, as described earlier, thereby forming a framework 40, whereby cells 42 will be formed by mutually facing open sides 44 of the shell parts 43. Such a framework is shown in part in top plan view in FIG. 17. Prior to or during rolling up, the cells can be filled with ice 5. Possibly, liquid ice may be poured in the rolled-up framework and then be frozen.

Such an ice dividing element 4 may, for example, be packaged with the ice 5 in a fitting, preferably slightly close-fitting partial package 20, in order to prevent the possibility of ice 5, at any rate, a significant part of the ice, flowing out of the framework. If the ice melts, it will thus at least largely remain trapped in the cells 42 and form ice therein again upon (re)freezing. After removal of the partial package 20, the whole can then be placed in a container 1 and, along with an added liquid, be shaken, for the formation of a milkshake. The framework 40 may be so configured that at least a part of the elements 41 can serve as knives 7, while, for example, a part of the elements, during shaking, can come loose, break or otherwise lose a mutual connection, or in that the element 4 can unroll to some extent after the package 20 has been removed, so that cells 42 are opened and moreover additional space is created to allow the ice 5 to move, relative to the elements 41 of the dividing element 4. Clearly, a framework 40 may be formed in a great many other ways, for example, as a sponge, for example a metal or plastic sponge having a relatively stiff cell structure. Alternatively, the ice 5 may be taken out of the framework and be placed with earlier-described dividing means in a container, together with a liquid, for the formation of the milkshake.

In FIG. 14 an alternative embodiment is shown, with the liquid V and the units of ice 5 jointly packaged in a partial container 21, while the ice dividing means 4 are included in a beaker 2 as partial container 20. The ice dividing means 4 are here represented as knives 7 which extend from the wall 31 of the beaker 2. The beaker can be a disposable beaker but is preferably a reusable beaker of a durable material. The second partial container 21 may, with the ice and the liquid, be stored in a freezing compartment at an earlier-mentioned temperature far below 0° C. and accordingly offered. Then this partial container 21 will subsequently need to be thawed at least partly in order for the liquid to become liquid again. To this end, the partial container 21 may, for example, be divisible into a part that comprises the units of ice and a part that comprises the liquid. The partial container 21 can be offered in the first partial container 20 or separately therefrom. The partial container 21 may, for example, be wholly or partly manufactured from foil. The liquid is preferably an airy liquid.

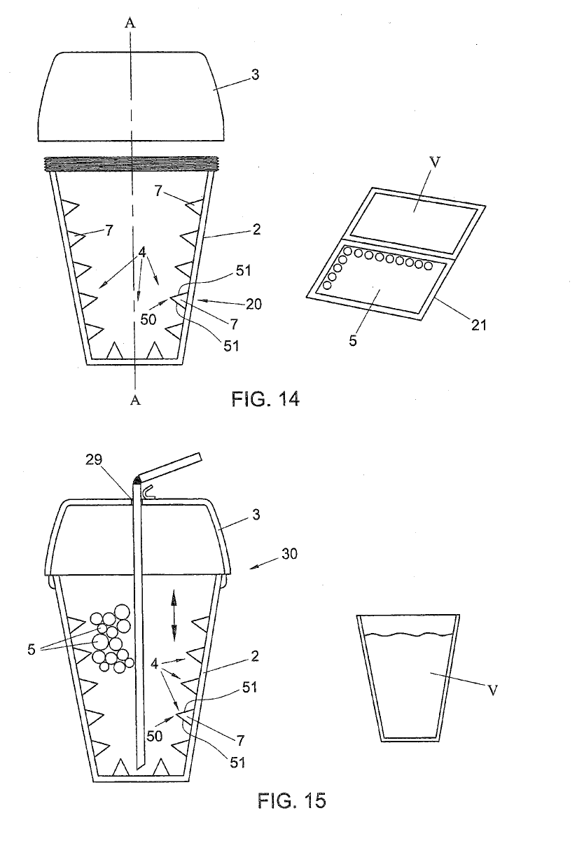

In FIG. 15 an embodiment is shown in which the beaker 2 with a lid 3 is provided as a package 30. The package 30 may be disposable as a whole and be offered. In the beaker dividing means 4 may be provided, for example, as a loose dividing element 4 or as integrated elements, such as knives 7. In this embodiment units of ice 5 are included in the beaker 2. Prior to use, a user only needs to add a liquid V, such as, for example, milk, and to shake the contents of the beaker 2 to be closed by the lid 3. The lid 3 may again be provided with an opening 29 for introducing a straw. The lid 3 may be so configured that it can serve as a measuring cup for the liquid V. The lid may, for instance, have a volume equal to the amount of liquid to be added, or, for example, a half, a third or a quarter thereof, thus readily allowing the liquid to be dosed. Such a package readily allows substantially direct consumption.

It is particularly advantageous when airy ice is used, in particular as in FIG. 15. To this end, the ice of the individual ice units 5 can contain a high percentage by volume of air, for example an overrun of more than 60%, more in particular more than 70%, for example 75% or more. In addition, or instead, the units of ice may also be arranged such that an ice body or a number of ice bodies are obtained, composed of the individual ice units 5, in which between the ice units relatively much air is enclosed, for example, at least 30% of the total volume, more in particular more than 40%, for example 50% or more (which is comparable to an overrun of 60, 80 and 100%, respectively). The units of ice 5 may be easily breakable from the or an ice body by the ice dividing means 4. Such an ice body may be formed from different units by joining them or may be formed as such a body at once, for example by extrusion, for example with supply of air.

FIG. 20 shows schematically and in sectional side elevation an embodiment of a container 1 having dividing means 4 therein, the dividing means having an axial height H which is approximately equal to the distance between the bottom 22A and the lid 3, so that axial movement in the direction X of the dividing means within the container 1 is at least substantially and preferably wholly prevented. The dividing means are thereby locked against movement. Such a lock or confinement of the dividing means can be used in all embodiments. Alternatively, the height H can be chosen to be smaller, thus allowing some axial movement. In the embodiment of FIG. 20, wall parts 9 are shown, at two levels seen in the height H. Naturally, more or fewer wall parts may be used, while they can also be omitted in embodiments. The knives 7 are shown with a substantially triangular shape, such as, for example, described earlier and, for example, as shown in FIG. 19.

In the embodiment shown in FIG. 20, the dividing means 4 has a substantially cylindrical shape, with a diameter D which is approximately equal to the least diameter D_{b} of the beaker 2 of the container 1. Thus, a radial confinement and lock can be obtained as well. In this embodiment, the lid 3 is provided with an opening 29 closable with a cap 52. It may, for example, be screwed, clamped or otherwise detachably fixed in the opening 29, preferably pilfer proof and/or tamper evident. The lid 3 may be clamped onto the beaker 2, for example with the aid of a clamped fit 53, while a seal 54 may be provided which seals against the beaker 2, preferably against the inner side thereof. Also, the lid 3 may for example be screwed or otherwise fixed on the beaker 2, such that upon shaking of the container the lid does not come off the beaker 2 and starts to leak. A user can remove the cap 52 and then pour the liquid through the opening 29 into the beaker 2, onto the ice units, not shown, in the beaker 2, for example until approximately 50 to 90%, more in particular between 50 and 75% of the volume of the container 1 is filled with ice and liquid. Then the cap 52 can be re-placed and the container 1 can be shaken, whereupon the milkshake is ready for consumption, for example, through the opening 29, by removing the lid 3 and/or by pouring out the milkshake. The opening 29 may be provided with a collar 55, for example down, into the inner space of the container 1, or up, such that if a user inserts a finger through the opening 29, the dividing means 4 and in particular knives 7 thereof cannot be reached. A container 1 according to the invention may be arranged such that the level of liquid that is poured into it is visible from the outside, especially there where a desired extent of filling of the container has been reached or is reached, for example, by virtue of partial translucency of the beaker or by providing a window.

Preferably, the container 1 closed in such a manner that the dividing means are not removable from it without damaging the container 1 and/or dividing means 4. In an alternative embodiment, the container 1 may be provided with a lid 3 which in a first position is detachable from the beaker, for example to allow the liquid to be poured into the beaker 2, and in a second position cannot be separated from the beaker anymore without damaging beaker 2 and/or lid 3.

Ice units 5 for use in or according to the invention can wholly consist of ice. In a package, such as a package for a semimanufacture, a partial package or a container 2 or at least in a device 1, all ice units may be equal to each other, or different units may be used therein, in size as well as in shape and in composition. The individual ice units may be composed of one or more kinds of ice. In FIG. 23 an ice unit 5 is shown, in a possible alternative embodiment. The ice unit 5 is here provided with a core 60 which consists at least substantially of ice, while a coating 61 is provided which extends over at least a part of the outer side of the core 60. The coating 61 may contain, for example, additives such as sweeteners, for example, sugars, while the core 60 comprises relatively little of such additives, in particular relatively little sweetener or other freezing point lowering ingredients. It has been found that in this way ice units can be used that freeze well and remain frozen at temperatures suitable to be generated in a customary icebox or freezer for domestic use, while yet sufficient additives, in particular sweeteners such as sugars can be added to make a good milkshake, also with liquids that are not or substantially not sweetened, such as milk. It has appeared that when according to the invention a milkshake is made with a desired sweetness, for example, a customary sweetness of milkshakes, utilizing wholly or virtually wholly unsweetened liquid such as milk, for example, in a volume ratio of one volume unit of liquid to one up to five, in particular between one and three, volume units of ice, it is undesirable to include all sweeteners in the ice because the freezing point of the ice is thereby lowered to the point where, for example, it already melts at temperatures at which it is normally stored and, in particular, will melt so fast that normal transport, for example, from a shop to one's home, in frozen state is rendered particularly difficult. By including a part of the sweeteners and possibly other ingredients that can lower the freezing point of ice from the ice in a coating or like additive, the consistency of the ice can be optimized, without this adversely affecting the taste of the eventual milkshake to be formed.

Clearly, coatings 61 may be used in which (also) other additives are added, for example, flavors, colors, emulsifiers and the like. Preferably, a coating is used that dissolves in the liquid V, so that the additives are taken up into the liquid V and hence in the milkshake. Also, the coating 61 may be so arranged that adhesion such as conglomeration of the ice units is thereby counteracted still further and/or are isolated to some extent.

In FIG. 24 an alternative embodiment is shown, in which in a container 2 the ice dividing means 4 are arranged, having therein ice units 5, while moreover in the container 2 an amount of additive 62 is arranged. The additive 62 may be, for example, an additive such as described with reference to FIG. 23, in particular, the additive 62 can contain sweeteners, so that the ice units need to contain less sweeteners and therefore can have a less low freezing temperature. In the embodiment shown, the additive 62, which may be both a monomaterial and a mixture, is shown as a layer dumped onto the bottom of the container, for example, granules or powder. However, it may also be solid unit, such as a block, or may be arranged in a different way, for example, wholly or partly as a coating on a part of the inner side of the container 2, the lid 3 and/or the ice dividing means 4, and/or divided between the units of ice 5, for example, as small spheres. Also possible are combinations of these forms of adding additives. Also in these embodiments, preferably a coating 61 and/or additive 62 or mixture thereof is used that is or are wholly or at least partly soluble in the liquid V. ‘Dissolving’ should herein be understood to mean that the additive is taken up and distributed in the liquid, for example in solution or suspension.

In a particularly advantageous embodiment, in the preparation of a milkshake according to the invention, milk is used as liquid V. With this, in a simple manner a good and nice milkshake can be prepared, while milk is normally present in households in cooled condition or in any case is simply obtainable and moreover, as far as relevant to the subject invention, sufficiently consistent in composition.

A container 1 with dividing means 4 is preferably disposable.

In the embodiment according to the invention, preferably dividing means are used that have an axial direction X and at least one substantially cylindrical or frustoconical wall with knives and/or wall parts that extend into an inner space of the dividing means. In particular, in the embodiments the dividing means can have, in the axial direction mentioned, a radial diameter that is many times greater than the average dimensions of the units of ice that are included therein, and be so free of obstacles for the ice units, other than the knives and/or wall parts 9, that liquid with ice units, under the influence of shaking and as a result of mass inertia and weight, are moved along and over cutting faces 51 of the knives 7 and/or wall parts 9 and, for example, are not sieved or otherwise blocked in their freedom of movement. In axial elevation the passage through the cylindrical dividing means is preferably substantially free of obstacles, other than the knives and any wall parts 9.

In the earlier-described embodiments, dividing means are provided as one or more plastic parts, such as, for example, foil, and/or as part of the container or parts thereof. Even so, also within the invention, dividing means 4 may be used that are formed wholly or partly from other materials. In particular embodiments, such dividing means may for example be wholly or partly formed from materials that are suitable for consumption, in particular human consumption, and, for example, FDA-approved. Such materials can be, or comprise, for example, sugars, candy or chocolate. The dividing means can have, for example, a coating of such a material or be built up therefrom. The coating may be soluble in the milkshake, in particular in the liquid. The dividing means manufactured from a consumable material may, for example, be taken out of the container after use and be eaten.

The end product of a method or use of devices and assemblies of the present invention will preferably be a milkshake with, for example, an overrun of gas, in particular air, of, for example, 70% or more, with a relatively high viscosity, which nonetheless is preferably drinkable through a straw. Such a viscosity can be designated as thick-liquid. The dividing means may still be in the milkshake.

The invention is by no means limited to the embodiments herein represented and discussed. Many variations thereon are possible within the framework of the invention outlined by the claims. In this description all combinations of parts of the embodiments specifically shown and described are understood to be described and represented as well.

1. A method for manufacturing a milkshake, wherein ice and a liquid with dividing means are put together in a substantially liquid-tight container, after which this container is shaken, such that the ice in the container is divided into small pieces by the dividing means, wherein the ice is preferably provided as a multiplicity of units of ice.

2. A method according to claim 1, wherein the dividing means are introduced loosely into the container, wherein the ice is introduced into the container preferably with the dividing means.

3. A method according to claim 1, wherein a container is used in which dividing means are included, fixedly or removably.

4. A method according to claim 1, wherein upon shaking of the container, the ice, in particular the units of ice, move relative to the dividing means, whereby turbulence and/or a mechanical force is generated in the liquid, preferably with foam being thereby formed in the liquid or the mixture of liquid and ice.

5. A method according to claim 1, wherein the dividing means with the ice are offered packed in a first partial container, wherein the liquid is preferably offered in a second partial container.

6. A method according to claim 1, wherein the ice is offered in at least partly melted condition in a package, wherein the ice can be frozen in the package, such that ice crystals of one or more of the original ice ingredients are obtained and/or preserved, wherein the package is preferably such that upon refreezing units of ice are formed.

7. A method according to claim 5, wherein the first partial container and the second partial container are connected by open sides to form one container and are shaken for the formation of the milkshake, wherein preferably one of the partial containers in the bottom thereof is provided with a sealed opening through which a straw is inserted.

8. Ice dividing means, provided with a multiplicity of knives for cutting ice, in particular units of ice, comprising a circumferential wall, which circumferential wall is preferably rollable, bendable or foldable, wherein the knives are preferably formed by inwardly bent parts of the circumferential wall.

9. An assembly for manufacturing a milkshake, at least comprising ice, in particular a multiplicity of units of ice and ice dividing means, in particular according to claim 8.

10. An assembly according to claim 9, wherein the dividing means and the ice are packed, preferably together in a first container or partial container.

11. An assembly according to claim 9, wherein the liquid is packed separately from the ice dividing means and/or the ice, preferably in a second partial container.

12. An assembly according to claim 8, wherein further a container is provided in which the ice dividing means, the ice and a liquid to be mixed therewith in the container are receivable and shakeable.

13. An assembly according to claim 8, wherein a container is used in which the dividing means are provided, preferably fixedly or removably.

14. An assembly according to claim 8, wherein the ice and the liquid are packed and stored such that the ice is at least partly melted, wherein the ice is packed such that it can be refrozen, at least such that ice crystals are obtained from at least one of the original ice ingredients, wherein preferably units of ice are obtained again.

15. An assembly according to claim 8, wherein a disposable container and/or dividing means are provided.

16. An assembly according to claim 8, wherein the dividing means are suitable for consumption.

17. Milkshake in a container, wherein ice dividing means are included in the container.

18. Unit of ice, in particular for use in a method according to claim 1 or with an assembly, provided with a coating, wherein in the coating at least sweeteners are included, in particular sweeteners that are soluble in a water-containing liquid such as milk.

19. An assembly according to claim 9, wherein additives are provided, as coating of ice units and/or parts of the container and/or of the ice dividing means and/or as solid parts discrete from the ice units, which additives comprise sweeteners which are at least partly soluble in a water-containing liquid such as milk.

20. A method according to claim 1, wherein additives are added in the form of a coating and/or solid parts, which additives are dissolved in the liquid.
